(19) United States
(12) Patent Application Publication
(10) Pub. No.: US 2014/0184487 A1
(43) Pub. Date: Jul. 3, 2014

(54) MANIPULATING VIRTUAL OBJECTS DISPLAYED BY A DISPLAY DEVICE THROUGH A PORTABLE DEVICE

(71) Applicant: HON HAI PRECISION INDUSTRY CO., LTD., New Taipei (TW)

(72) Inventors: YI-WEN CAI, New Taipei (TW); CHUN-MING CHEN, New Taipei (TW); CHUNG-I LEE, New Taipei (TW)

(73) Assignee: HON HAI PRECISION INDUSTRY CO., LTD., New Taipei (TW)

(21) Appl. No.: 13/887,421

(22) Filed: May 6, 2013

(30) Foreign Application Priority Data
Dec. 27, 2012 (TW) 101150611

(51) Int. Cl. G06F 3/01

(52) U.S. Cl. CPC G06F 3/01
USPC 345/156

(57) ABSTRACT

A virtual object in a virtual scene displayed on a display device disposed in a structure is capable of being manipulated by a portable device including a wireless communication unit, an image sensing unit, a display unit, and an input unit. The image sensing unit produces snapshot information corresponding to the virtual scene. The display unit displays snapshot image(s) according to the snapshot information, and displays manipulation option(s) according to manipulation item information of the virtual object provided by the display device. The input unit produces selection parameter(s) in response to a selection operation corresponding to the snapshot image(s), and produces manipulation parameter(s) in response to user input with respect to the manipulation option(s). The wireless communication unit transmits the manipulation parameter(s) to the display device to enable the display device to manipulate the virtual object according to the manipulation parameter(s).

### CROSS-REFERENCE OF RELATED APPLICATIONS

Relevant subject matter is disclosed in a co-pending U.S. patent application (application Ser. No. 13/437,996), which is assigned to the same assignee as this patent application.

### BACKGROUND

1. Technical Field

The present disclosure relates to manipulation of virtual objects, for example, images of an object which are displayed by a display device, and particularly to the manipulation of virtual objects on a display device, through a portable device.

2. Description of Related Art

Very large display devices such as electronic papers or complete display walls, which can be fixed on a structure such as a building or a vehicle, are common. The larger display devices can display a virtual scene representing a particular background. However, seeing the same or multiple sceneries over and over without interaction can be boring.

Thus, there is room for improvement in the art.

### BRIEF DESCRIPTION OF THE DRAWINGS

Many aspects of the present disclosure can be better understood with reference to the drawings. The components in the drawing(s) are not necessarily drawn to scale, the emphasis instead being placed upon clearly illustrating the principles of the present disclosure. Moreover, in the drawing(s), like reference numerals designate corresponding parts throughout the several views.

FIG. 1 is a block diagram of an embodiment of a display system of the present disclosure.

FIG. 2 is a schematic diagram of the display of a virtual scene through the display system shown in FIG. 1.

FIG. 3 is a schematic diagram of the use of the portable device of the display system shown in FIG. 1.

FIG. 4 is a flowchart of an embodiment of a display method implemented through the display system shown in FIG. 1.

### DETAILED DESCRIPTION

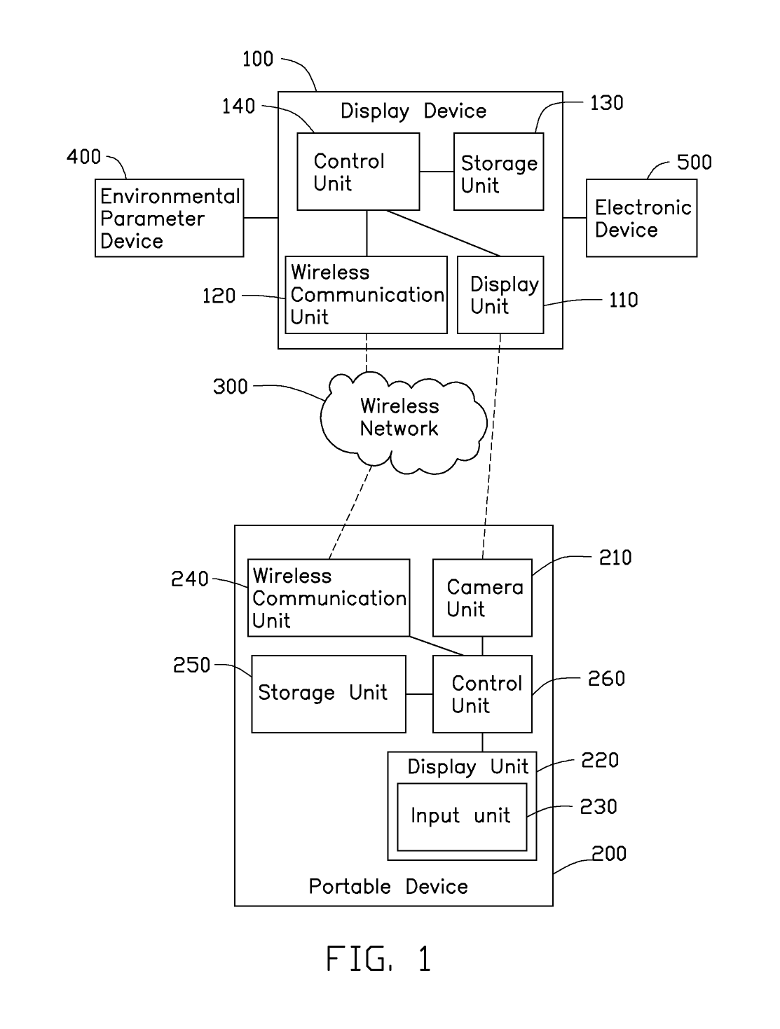

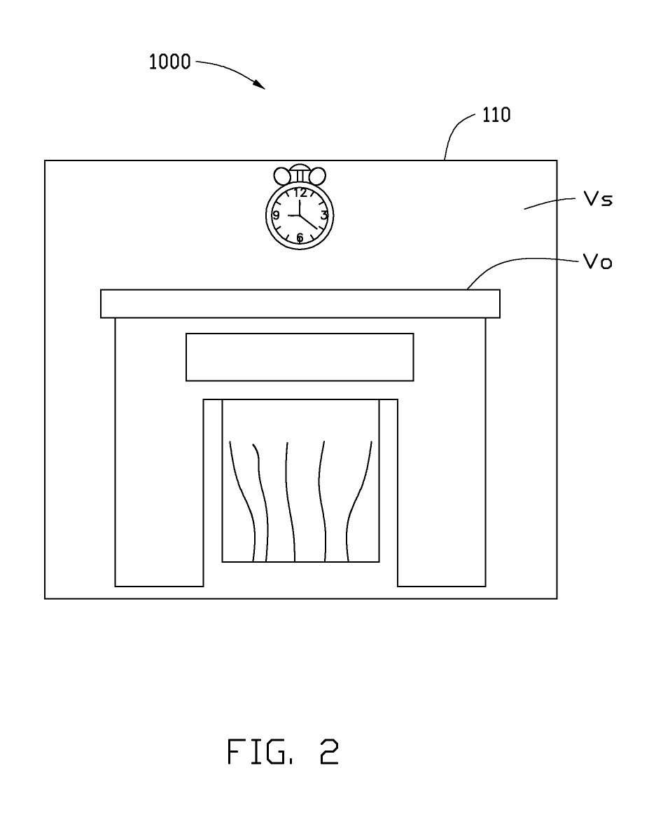

FIG. 1 is a block diagram of an embodiment of a display system of the present disclosure. The display system includes a display device 100 and a portable device 200. The display device 100 includes a display unit 110, a wireless communication unit 120, a storage unit 130, and a control unit 140. The display unit 110 is an electronic display with a large size, which is disposed in a structure 1000 (see FIG. 2) such as a building or a vehicle. The display unit 110 adds to the decoration and interest of the structure 1000 by displaying a virtual scene Vs (see FIG. 2), thereby simulating a scene such as a living room.

In the illustrated embodiment, the display unit 110 is an electronic paper disposed in the structure 1000, which is fixed on a surface of a wall of the structure 1000. In other embodiments, the display unit 110 can be another type of electronic display such as liquid crystal display (LCD), and can be a display wall composed of a plurality of coupled display devices such as televisions. In addition, the display unit 110 can be fixed on other portions of the structure 1000, for example, a surface of a ceiling or a floor of the structure 1000, or in an opening of the structure 1000. Furthermore, the display unit 110 can be disposed other than in the structure 1000. The wireless communication unit 120 communicates with the portable device 200 through a wireless network 300 such as a short distance wireless network implemented according to, for example, BLUETOOTH telecommunication standard. The storage unit 130 may include a random access memory, a non-volatile memory, and/or a hard disk drive, which may store instructions to be executed by the control unit 140 and data related to the instructions.

FIG. 2 is a schematic diagram of the display of the virtual scene Vs through the display system shown in FIG. 1. The control unit 140 may include a graphics card to control the display unit 110 to display the virtual scene Vs on the wall of the structure 1000 according to, for example, image(s) such as still photographs, moving pictures, or videos stored in the storage unit 130. The virtual scene Vs can represent, for example, a living room, a bedroom, or the countryside. In the illustrated embodiment, the display device 100 receives snapshot information Is (not shown) concerning the virtual scene Vs for display by the display device 100 and selection parameter(s) Pm (not shown) from the portable device 200 through the wireless communication unit 120, and the control unit 140 can determine whether a virtual object Vo in the virtual scene Vs has been selected through the portable device 200 based on the snapshot information Is and the selection parameter(s) Pm. The virtual object Vo can be, for example a figure of an object which is being displayed according to an image such as a still photograph, a moving picture, or a video stored in the storage unit 130, while the virtual scene Vs may include a plurality of the virtual objects Vo.

The snapshot information Is may include an image with a file format such as JPEG, GIF, or PNG. The selection parameter(s) Pm may include position(s), for example, coordinate(s), with respect to the image in the snapshot information Is. The virtual object Vo is a portion of the virtual scene Vs. For instance, when the virtual scene Vs represents a living room, the virtual object Vo can represent a single object in the living room which can be a furniture such as a fireplace, an air conditioner, or a lighting device. The virtual object Vo can also represent other types of object such as an animal or a plant when, for example, the virtual scene Vs shows the countryside.

The control unit 140 determines whether the virtual object Vo has been selected by, for example, comparing the graphical characteristic(s) (for example, shape and color) of a portion of the image in the snapshot information Is corresponding to the selection parameter(s) Pm with the graphical characteristic(s) of a portion of an image stored in the storage unit 130 which concerns the virtual scene Vs, wherein the portion corresponds to the virtual object Vo, and the virtual object Vo is determined to have been selected when the graphical characteristics are equivalent. If the virtual object Vo is selected, the control unit 140 provides manipulation item information Im (not shown) of the virtual object Vo to the portable device 200. The manipulation item information Im includes various manipulation(s) which can be performed with respect to an object which the virtual object Vo represents. The manipulation(s) can be stored in the storage unit 130 as, for example, a data file concerning information of the virtual object Vo, and the control unit 140 can provide the manipulation item information Im by, for example, retrieving the possible or available manipulation(s) from the storage unit 130, and then producing the manipulation item information Im according to the manipulation(s). For instance, when the virtual object Vo represents a fireplace, the manipulation item information Im may include such manipulations relevant to the fireplace such as adding firewood and reducing the amount of firewood.

The control unit 140 manipulates the virtual object Vo according to manipulation parameter(s) Pm (not shown) received from the portable device 200, wherein the manipulation parameter(s) Pm includes, for example, an identification word representing the manipulation(s) in the manipulation item information Im to be performed with respect to the object which the virtual object Vo represents. For instance, when the virtual object Vo represents a fireplace, the manipulation parameter(s) Pm may represent adding firewood or reducing firewood, and may also represent the quantities of firewood to be added or reduced. The control unit 140 manipulates the virtual object Vo by changing a portion of an image concerning the virtual scene Vs which corresponds to or shows the virtual object Vo, for example, a figure in the image which represents the virtual object Vo, according to the manipulation parameter(s) Pm. For instance, when the manipulation parameter(s) Pm represent adding firewood to a fireplace, the control unit 140 replaces a figure representing the fireplace with another figure representation of a fireplace having a bigger fire.

In the illustrated embodiment, when the manipulation parameter(s) Pm correspond to environmental parameter(s) Pe (not shown) of a scene where the display device 100 is located, the control unit 140 may control an environmental parameter device 400 disposed in the scene to change the environmental parameter(s) Pe according to the manipulation parameter(s) Pm. The environmental parameter device 400 can be, for example, an air conditioner, and the environmental parameter(s) Pe can be, for example, air temperature, humidity, or luminosity. For instance, when the environmental parameter device 400 is an air conditioner and the manipulation parameter(s) Pm include an objective temperature value, the control unit 140 controls the environmental parameter device 400 to change air temperature according to the objective temperature value in the manipulation parameter(s) Pm.

In addition, when the manipulation parameter(s) Pm correspond to device parameter(s), for example, volume of sound, odors, or sensory stimulation such as touch or temperature, of an electronic device 500, for example, a sound producing device such as a speaker, an odor producing device such as an essential oil atomizer, or a sensation producing device such as a sensory glove, the control unit 140 can control the electronic device 500 to change the device parameter(s) of the electronic device 500 according to the manipulation parameter(s) Pm. For instance, the control unit 140 can control a sound producing device to change the volume of the sound producing device according to a volume value in the manipulation parameter(s) Pm.

The portable device 200 is a portable electronic device such as a tablet computer, a smart phone, or a notebook computer. The portable device 200 includes an image sensing unit 210, a display unit 220, an input unit 230, a wireless communication unit 240, a storage unit 250, and a control unit 260. The image sensing unit 210 includes image sensing device(s) such as camera(s), which is capable of producing the snapshot information Is, including the image of a portrait of a screen of the display unit 110 of the display device 100 in response to, for instance, actuating a button for producing the snapshot information Is.

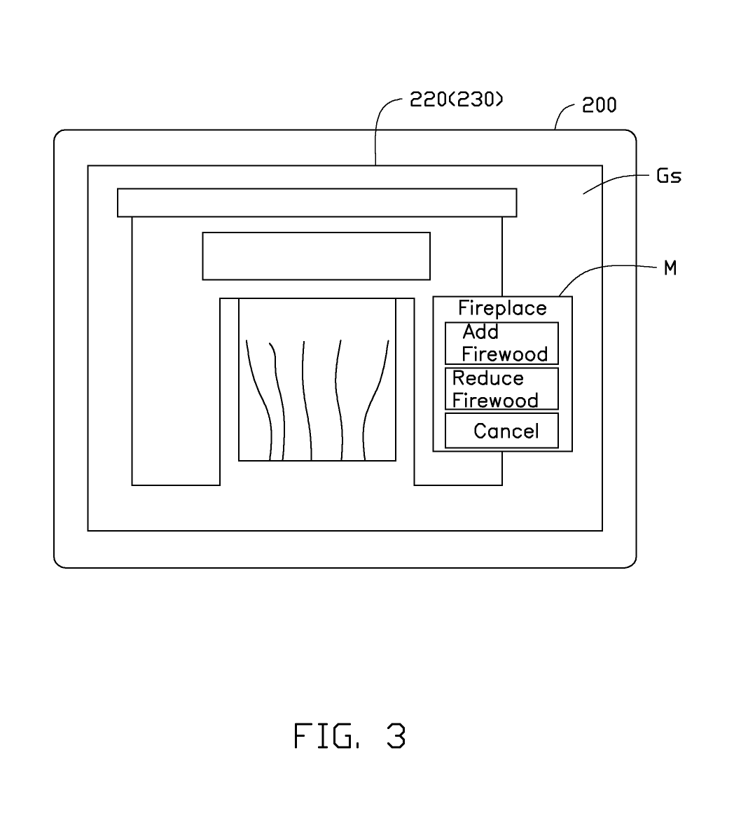

FIG. 3 is a schematic diagram of the use of the portable device 200 of the display system shown in FIG. 1. The display unit 220 displays snapshot image(s) Gs according to the snapshot information Is, such that the snapshot image(s) Gs correspond to the image in the snapshot information Is. The display unit 220 may include an electronic display such as a liquid crystal display (LCD). The input unit 230 produces the selection parameter(s) Ps in response to a selection operation with respect to the snapshot image(s) Gs. In the illustrated embodiment, the input unit 230 is a touch panel disposed on the display unit 220 to correspond to a display portion of the display unit 220, such that touch operations with respect to the input unit 230 which may include the selection operation can be performed with respect to the snapshot image(s) Gs. The input unit 230 has a coordinate system corresponding to a coordinate system of the display unit 220. When a touch operation including, for example, a press (and a drag), is detected by the input unit 230, the input unit 230 produces touch position parameter(s) concerning the touch operation which include coordinate(s) of the input unit 230, wherein the touch position parameter(s) may include the selection parameter(s) Ps which include coordinate(s) with respect to the image in the snapshot information Is. In other embodiments, the input unit 230 can be another type of input device such as a mouse.

The display unit 220 further displays manipulation option menu M including manipulation option(s) with respect to the virtual object Vo according to the manipulation item information Im of the virtual object Vo received from the display device 100. The manipulation option(s) include, for example, manipulations of the fireplace such as adding and reducing firewood. In the illustrated embodiment, the input unit 230 produces the manipulation parameter(s) Pm in response to an input operation with respect to the manipulation option(s) in the manipulation option menu M, wherein the input operation may include, for example, a selection operation such as a press carried out on the menu M. In other embodiments, the input unit 230 can produce the manipulation parameter(s) Pm based on the manipulation item information Im instead of the input operation. The wireless communication unit 240 transmits the manipulation parameter(s) Pm to the display device 100. In the illustrated embodiment, the wireless communication unit 240 transmits the manipulation parameter(s) Pm immediately after the manipulation parameter(s) Pm are produced. In other embodiments, the wireless communication unit 240 transmits the manipulation parameter(s) Pm in response to a particular operation, for example, a movement or a shaking of the portable device 200. For instance, when the virtual object Vo represents an animal while the manipulation parameter(s) Pm are representing feeding the animal, the manipulation parameter(s) Pm can be transmitted in response to a movement of pretending to throw the portable device 200 to the virtual object Vo.

The storage unit 250 may include a random access memory, a non-volatile memory, and/or a hard disk drive, which may store instructions to be executed by the control unit 260 and data related to the instructions. In other embodiments, the control unit 260 can determine whether the virtual object Vo is selected based on the snapshot information Is and the selection parameter(s) Pm, and provides the manipulation item information Im when the virtual object Vo is selected, through executing an application program in the storage unit 250, instead of using the control unit 140 of the display device 100 to determine the selection of the virtual object Vo and provide the manipulation item information Im.

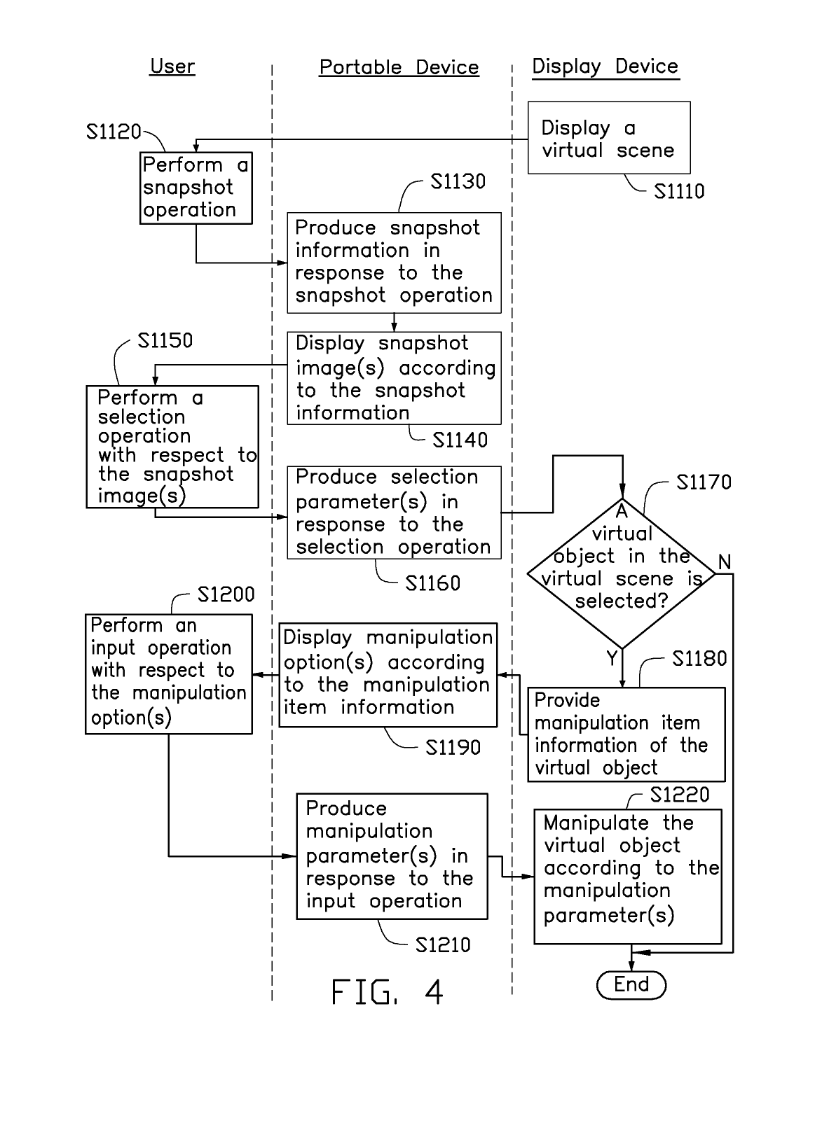

FIG. 4 is a flowchart of an embodiment of a display method implemented through the display system shown in FIG. 1. The display method of the present disclosure is as follows. Steps S1110, S1170-S1180 and S1220 are implemented through instructions stored in the storage unit 130 of the display device 100. Steps S1130-S1140, S1160, S1190, and S1210 are implemented through instructions stored in the storage unit 250 of the portable device 200. Depending on the embodiment, additional steps may be added, others removed, and the ordering of the steps may be changed.

In step S1110, the virtual scene Vs is displayed through the display device 100. In the illustrated embodiment, the virtual scene Vs is displayed through the display unit 110 of the display device 100, wherein the display unit 110 is an electronic display with a large size disposed in the structure 1000, for example, an electronic paper disposed in a building or a vehicle. The display unit 110 decorates and adds interest to the structure 1000 by displaying the virtual scene Vs, thereby simulating a scene such as a living room.

In step S1120, a snapshot operation is performed by a user through the portable device 200 communicating with the display device 100 through the wireless network 300.

In step S1130, the snapshot information Is is produced in response to the snapshot operation through the portable device 200.

In step S1140, the snapshot image(s) Gs are displayed on the portable device 200 according to the snapshot information Is.

In step S1150, a selection operation is performed by the user with respect to the snapshot image(s) Gs.

In step S1160, the selection parameter(s) Pm are produced in response to the selection operation through the portable device 200.

In step S1170, a determination is made as to whether the virtual object Vo in the virtual scene Vs has been selected based on the snapshot information Is and the selection parameter(s) Pm through the display device 100. If yes, step S1180 is implemented; otherwise, the method is terminated.

In step S1180, the manipulation item information Im of the virtual object Vo is provided through the display device 100. In other embodiments, Steps S1170-S1180 can be implemented through the portable device 200.

In step S1190, the manipulation option(s) are displayed according to the manipulation item information Im through the portable device 200.

In step S1200, an input operation is performed by the user with respect to the manipulation option(s).

In step S1210, the manipulation parameter(s) Pm are produced in response to the input operation through the portable device 200.

In step S1220, the virtual object Vo is manipulated according to the manipulation parameter(s) Pm. The virtual object Vo is manipulated by changing a portion of an image concerning the virtual scene Vs according to the manipulation parameter(s) Pm, wherein the portion corresponds to the virtual object Vo.

In addition, when the manipulation parameter(s) Pm correspond to the environmental parameter(s) Pe, the environmental parameter device 400 such as an air conditioner can be controlled to change the environmental parameter(s) Pe such as air temperature, humidity, or luminosity according to the manipulation parameter(s) Pm through the display device 100. Furthermore, when the manipulation parameter(s) Pm correspond to the device parameter(s) of the electronic device 500, the electronic device 500 being a sound producing device for example, an odor producing device, or a sensation producing device can be controlled to change the device parameter(s) such as the volume, the odors, or the touch of the electronic device 500, through the display device 100 according to the manipulation parameter(s) Pm.

The display system enables a user to interact with a large display device through a small portable device, thereby manipulating virtual objects being displayed by the display device.

While the disclosure has been described by way of example and in terms of a preferred embodiment, the disclosure is not limited thereto. On the contrary, it is intended to cover various modifications and similar arrangements as would be apparent to those skilled in the art. Therefore the range of the appended claims should be accorded the broadest interpretation so as to encompass all such modifications and similar arrangements.

What is claimed is:

1. A display device for manipulating a virtual object in a virtual scene, comprising:
a display unit;
a wireless communication unit communicating with a portable device; and
a control unit controlling the display unit to display the virtual scene, providing manipulation item information of the virtual object in the virtual scene to the portable device when the virtual object is selected through the portable device, and manipulating the virtual object according to one or more manipulation parameters received from the portable device.

2. The display device of claim 1, wherein the display unit is disposed on a structure to display the virtual scene.

3. The display device of claim 1, wherein the control unit determines whether the virtual object has been selected according to snapshot information and one or more selection parameters received from the portable device.

4. The display device of claim 1, wherein the control unit manipulates the virtual object by changing a portion of an image of the virtual scene corresponding to the virtual object according to the one or more manipulation parameters.

5. The display device of claim 1, wherein the control unit controls an environmental parameter device to change one or more environmental parameters according to the one or more manipulation parameters when the one or more manipulation parameters correspond to the one or more environmental parameters.

6. The display device of claim 1, wherein the control unit controls a sound producing device to change one or more device parameters of the sound producing device according to the one or more manipulation parameters when the one or more manipulation parameters correspond to the one or more device parameters.

7. The display device of claim 1, wherein the control unit controls an odor producing device to change one or more device parameters of the odor producing device according to the one or more manipulation parameters when the one or more manipulation parameters correspond to the one or more device parameters.

8. The display device of claim 1, wherein the control unit controls a sensation producing device to change one or more device parameters of the sensation producing device according to the one or more manipulation parameters when the one or more manipulation parameters correspond to the one or more device parameters.

9. A portable device for manipulating a virtual object in a virtual scene displayed by a display device, comprising:
a wireless communication unit communicating with the display device;
an image sensing unit producing snapshot information corresponding to the virtual scene displayed by the display device;
a display unit displaying one or more snapshot images according to the snapshot information; and
an input unit producing one or more selection parameters in response to a selection operation corresponding to the one or more snapshot images;
wherein the display unit displays one or more manipulation options according to manipulation item information of the virtual object in the virtual scene, the input unit produces one or more manipulation parameters in response to an input operation corresponding to the one or more manipulation options, the wireless communication unit transmits the one or more manipulation parameters to the display device.

10. The portable device of claim 9, wherein the control unit determines whether the virtual object has been selected according to the snapshot information and the one or more selection parameters.

11. The portable device of claim 10, wherein the control unit provides the manipulation item information when the virtual object is selected.

12. A display method for manipulating a virtual object in a virtual scene, comprising:
displaying the virtual scene through a display device;
determining whether the virtual object in the virtual scene is selected through a portable device communicating with the display device through a wireless network;
providing manipulation item information of the virtual object when the virtual object is selected; and
manipulating the virtual object according to one or more manipulation parameters produced by the portable device.

13. The display method of claim 12, wherein the step of displaying the virtual scene comprises displaying the virtual scene through the display device disposed on a structure.

14. The display method of claim 12, further comprising:
producing the snapshot information through the portable device;
displaying one or more snapshot images according to the snapshot information through the portable device;
producing the one or more selection parameters in response to a selection operation corresponding to the one or more snapshot images through the portable device;
displaying one or more manipulation options according to the manipulation item information through the portable device; and
producing the one or more manipulation parameters in response to an input operation corresponding to the one or more manipulation options through the portable device.

15. The display method of claim 12, wherein the step of manipulating the virtual object comprises changing a portion of an image of the virtual scene corresponding to the virtual object according to the one or more manipulation parameters.

16. The display method of claim 12, further comprising controlling an environmental parameter device to change one or more environmental parameters according to the one or more manipulation parameters when the one or more manipulation parameters correspond to the one or more environmental parameters.

17. The display method of claim 12, further comprising controlling a sound producing device to change one or more device parameters of the sound producing device according to the one or more manipulation parameters when the one or more manipulation parameters correspond to the one or more device parameters.

18. The display method of claim 12, further comprising controlling an odor producing device to change one or more device parameters of the odor producing device according to the one or more manipulation parameters when the one or more manipulation parameters correspond to the one or more device parameters.

19. The display method of claim 12, further comprising controlling a sensation producing device to change one or more device parameters of the sensation producing device according to the one or more manipulation parameters when the one or more manipulation parameters correspond to the one or more device parameters.
